(19) United States
(12) Patent Application Publication
(10) Pub. No.: US 2026/0368082 A1
(43) Pub. Date: Nov. 19, 2026

(54) MEMORY SYSTEMS, CONTROLLERS, OPERATING METHODS, STORAGE MEDIA, AND PROGRAM PRODUCTS

(71) Applicant: Yangtze Memory Technologies Co., Ltd., Wuhan (CN)

(72) Inventor: Xianwu Luo, Wuhan (CN)

(21) Appl. No.: 19/306,562

(22) Filed: Aug. 21, 2025

(30) Foreign Application Priority Data
Mar. 31, 2025 (CN) 202510398098.9

(51) Int. Cl. G06F 12/02

(52) U.S. Cl. CPC G06F 12/0246; G06F 2212/7205

(57) ABSTRACT

An example method comprises: performing a garbage collection operation in a first time period; and performing a write operation in response to a write operation instruction from a host in a second time period, wherein the first time period and the second time period occur alternately, and a resource usage indicator for the second time period is positively correlated with a non-valid page ratio, wherein a non-valid page includes a non-valid page in a memory block where the write operation is performing a write..

### CROSS-REFERENCE TO RELATED APPLICATION

This application claims priority to and the benefit of Chinese Patent Application 202510398098.9, filed on Mar. 31, 2025, which is hereby incorporated by reference in its entirety.

### TECHNICAL FIELD

The present disclosure relates to the field of semiconductor technology, and in particular to memory systems, memory controllers, operating methods, computer-readable storage media, and computer program products.

### BACKGROUND

In a memory system, when over provisioning (OP) is relatively stable, a memory block, such as a virtual block (VB), becomes larger and larger. Once it enters a force garbage collection (FGC) stage, when the logical saturation of valid page count (e.g., the proportion of valid page count) of the memory block is high, garbage collection is performed on multiple source memory blocks to release one memory block.

### BRIEF DESCRIPTION OF THE DRAWINGS

The accompanying drawings are incorporated into the specification and form a part of the specification, and illustrating examples in accordance with the present disclosure and used together with the specification to explain principles of the present disclosure. It is apparent that the figures described below are only some examples of the present disclosure. For those skilled in the art, other figures may be obtained from these figures.

FIG. 1 shows a block diagram of an example system with a memory in an example of the present disclosure.

FIG. 2A illustrates a block diagram of a memory system.

FIG. 2B illustrates a block diagram of another memory system.

FIG. 2C illustrates a block diagram of yet another memory system.

FIG. 3 shows a schematic diagram of a peripheral circuit provided by an example of the present disclosure.

FIG. 4 shows a schematic diagram of an architecture of a memory system in an example of the present disclosure.

FIG. 5 shows a flowchart of a method for operating a memory system in an example of the present disclosure.

FIG. 6A shows a flowchart of a method for operating a memory system in another example of the present disclosure.

FIG. 6B shows a flowchart of a method for operating a memory system in yet another example of the present disclosure.

FIG. 7 shows a flowchart of a method for operating a memory system in yet another example of the present disclosure.

FIG. 8 shows a flowchart of a method for operating a memory system in yet another example of the present disclosure.

FIG. 9A shows a flowchart of a method for operating a memory system in yet another example of the present disclosure.

FIG. 9B shows a flowchart of a method for operating a memory system in yet another example of the present disclosure.

FIG. 10 shows a flowchart of a method for operating a memory system in yet another example of the present disclosure.

FIG. 11 shows a flowchart of a method for operating a memory system in yet another example of the present disclosure.

FIG. 12 shows a schematic diagram of force garbage collections over time under different VPC logic saturations of first source memory block.

### DETAILED DESCRIPTION

Illustrated examples will now be described more comprehensively with reference to the accompanying drawings. However, the illustrated examples may be implemented in various forms and should not be construed as limited to the examples described herein. On the contrary, providing these examples will make the present disclosure comprehensive and complete, and fully conveys the concept of the illustrated examples to those skilled in the art. The same reference numbers in the figures represent the same or similar parts, so repeated descriptions of them will be omitted.

The features, structures, or characteristics described in the present disclosure may be combined in any suitable manner in one or more examples. In the following description, many specific details are provided to provide a thorough understanding of examples of the present disclosure. However, those skilled in the art will appreciate that the technical solution of the present disclosure may be practiced without omitting one or more specific details, or other methods, components, devices, steps, etc. may be employed. In other cases, well-known methods, devices, implementations, or operations are not shown or described in detail to avoid obscuring aspects of the present disclosure.

The accompanying drawings are only schematic illustrations of the present disclosure, and the same reference numbers in the drawings represent the same or similar parts, so repeated descriptions of them will be omitted. Some of block diagrams shown in the accompanying drawings may not necessarily correspond to physically or logically independent entities. These functional entities may be implemented in software, or in at least one hardware module or integrated circuit, or in different networks and/or processor devices and/or microcontroller devices.

The flowcharts shown in the drawings are only example illustrations and do not necessarily include all the content and operations, and are not necessarily executed in the order described. For example, some operations may be decomposed, while others may be merged or merged partially, so the actual order of execution may change according to actual situation.

In the specification, the terms “a”, “an”, “the”, “said”, and “at least one” are used to indicate the existence of at least one element/component/etc. The terms “including”, “comprising”, and “having” are used to indicate open-ended inclusion and refer to the existence of additional elements/components/etc., in addition to the listed ones. The terms “first”, “second”, “third”, etc., are only used as markers and not to limit the count of objects thereof.

The terms used in the present application are described and explained below.

A valid page refers to a page in a memory block that stores valid data.

A non-valid page refers to a page in a memory block that stores discarded data.

A free page refers to a page in a memory block which has been erased and data has not been stored in. Data may be directly written into a free page.

A non-valid page is a general term for invalid and free pages in a memory block, or in other words, a non-valid page is a page other than a valid page in a memory block.

The total number of pages in a memory block refers to the total of the count of valid pages, non-valid pages, and free pages in a memory block.

A non-valid page ratio refers to the proportion of non-valid pages in all pages in a memory block, which may also be obtained through 1 minus a valid page ratio.

The logical saturation of valid page count refers to the proportion of valid pages in all pages in a memory block.

The free memory block count refers to the count of memory blocks that may be written with data.

In a memory system, during the process of a force garbage collection, it is sometimes necessary to perform a host-write operation. If the write speed of the host-write operation is relatively fast, free memory blocks are easily exhausted and even the write cannot be continued. If the write speed of the host-write operation is slow, although garbage collection may release memory blocks in time, the dirty performance and input-output (IO) latency during the write operation may be relatively poor. The speed adjustment between host-write and garbage collection requires attention and handling.

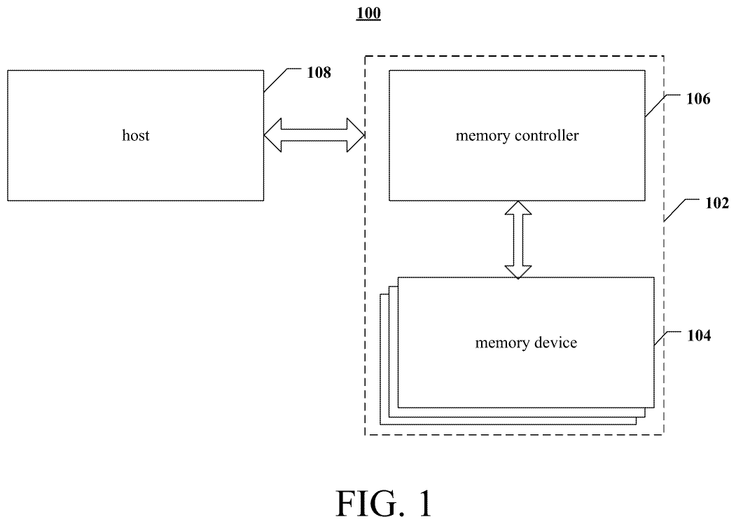

FIG. 1 shows a block diagram of an example system with a memory device in an example of the present disclosure. The system 100 may be a mobile phone, desktop computer, portable computer, tablet computer, vehicle computer, game console, printer, positioning device, wearable electronic device, smart sensor, virtual reality (VR) device, augmented reality (AR) device, or any other suitable electronic device with storage therein. As shown in FIG. 1, the system 100 may include a host 108 and a memory system 102. The memory system 102 has one or more memory devices 104 and a memory controller 106.

The host 108 may be a processor of an electronic device, such as a Central Processing Unit (CPU), or a System on Chip (SoC), such as an Application Processor (AP). The host 108 may be coupled to the memory controller 106 and configured to send data to or receive data from the memory device 104 through the memory controller 106. For example, the host 108 may send program data in a programming operation or receive read data in a read operation. The host 108 is configured to receive and send instructions and commands to and from the memory controller 106 of the memory system 102. The memory controller 106 executes or implements multiple functions and operations provided in the present disclosure, which will be described below.

The memory device 104 may be any memory device disclosed in the present disclosure, such as a NAND flash storage device, which includes a page buffer with multiple sections. Note that for illustrative purposes, the NAND flash memory is only one example of a memory device. The memory device 104 may include any suitable non-volatile memory, such as NOR flash memory, Ferroelectric Random Access Memory (FeRAM), Phase Change Memory (PCM), Magnetic Random Access Memory (MRAM), Spin Transfer Torque Random Access Memory (STT-RAM), or Resistive Random Access Memory (RRAM). In some implementations, the memory device 104 includes a three-dimensional (3D) NAND flash memory.

The memory controller 106 may be implemented through microprocessors, microcontrollers (also known as microcontroller units (MCUs)), digital signal processors (DSPs), application specific integrated circuits (ASICs), field programmable gate arrays (FPGAs), programmable logic devices (PLDs), state machines, gate control logic, discrete hardware circuits, and other suitable hardware, firmware, and/or software configured to perform various functions described in detail below.

According to some implementations, the memory controller 106 is coupled to the memory device 104 and the host 108, and configured to control the memory device 104. The memory controller 106 may manage data stored in the memory device 104 and communicate with the host 108. In some implementations, the memory controller 106 is designed to operate in low duty cycle environments such as Secure Digital (SD) cards, Compact Flash (CF) cards, Universal Serial Bus (USB) flash drives, or other media used in electronic devices such as personal computers, digital cameras, mobile phones, etc. In some implementations, the memory controller 106 is designed to operate solid-state drives (SSDs) in high duty cycle environments or as an embedded multimedia card (eMMC) for data storage devices used in mobile devices such as smartphones, tablets, laptops, etc., and enterprise storage arrays. The memory controller 106 may be configured to control operations of the memory device 104, such as read, erase, and program operations, by providing instructions such as read commands to the memory device 104. For example, the memory controller 106 may be configured to provide read instructions to peripheral circuits of the memory device 104 to control read operations. The memory controller 106 may also be configured to manage various functions related to data stored or to be stored in the memory device 104, including but not limited to bad block management, garbage collection (GC), logical to physical address translation, wear leveling, etc. In some implementations, the memory controller 106 is also configured to process error correcting codes (ECC) for data read from or written to the memory device 104. The memory controller 106 may also perform any other suitable function, such as formatting the memory device 104.

The memory controller 106 may communicate with an external device (such as the host 108) according to a specific communication protocol. For example, the memory controller 106 may communicate with external devices through at least one of various interface protocols, such as USB protocol, Multi Media Card (MMC) protocol, Peripheral Component Interconnect (PCI) protocol, Peripheral Component Interconnect Express (PCI-E) protocol, Advanced Technology Attachment (ATA) protocol, Serial ATA protocol, Parallel ATA protocol, Small Computer Small Interface (SCSI) protocol, Enhanced Small Drive Interface (ESDI) protocol, Integrated Drive Electronics (IDE) protocol, Firewire protocol, etc.

The memory controller 106 and one or more memory devices 104 may be integrated into various types of storage devices, such as being included in the same package (e.g., Universal Flash Storage (UFS) package or eMMC package). That is, the memory system 102 may be implemented and packaged into different types of terminal electronic products.

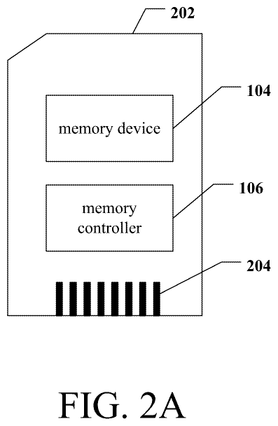

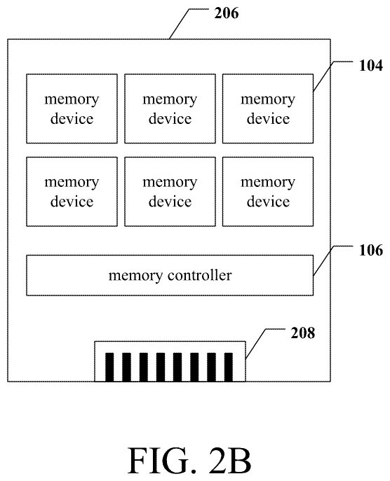

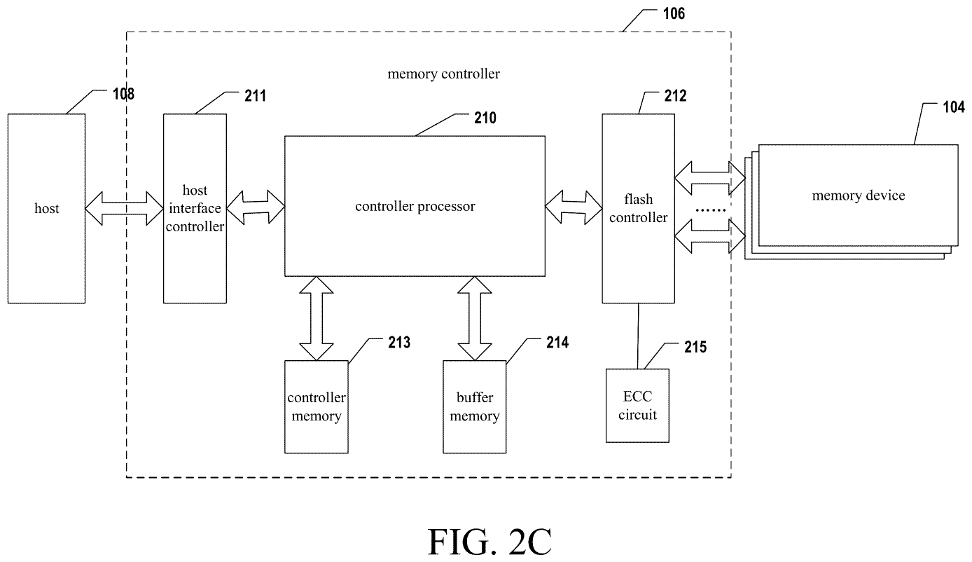

In one example shown in FIG. 2A, the memory controller 106 and the memory device 104 may be integrated into the memory card 202. The memory card 202 may include a PC card (Personal Computer Memory Card International Association (PCMCIA), a CF card, a Smart Media (SM) card, a memory stick, a Multimedia Card (MMC), a SD card, UFS, etc. The memory card 202 may also include a memory card connector 204 that couples the memory card to a host (e.g., host 108 in FIG. 1).

In another example shown in FIG. 2B, the memory controller 106 and multiple memory devices 104 may be integrated into the solid-state drive 206. The solid-state drive 206 may also include a solid-state drive connector 208 that couples the solid-state drive 206 to a host (e.g., host 108 in FIG. 1). In some implementations, storage capacity and/or operating speed of the solid-state drive 206 are greater than those of the memory card 202.

FIG. 2C shows a schematic diagram of an example memory controller with a memory system in an example of the present disclosure. As shown in FIG. 2C, the memory controller 106 is coupled and connected to the host 108 and one or more memory devices 104, respectively, for controlling to send data from the host 108 to the memory devices 104 or read data from the memory devices 104 back to the host 108. The memory controller 106 includes at least: a controller processor 210, a host interface controller 211, a flash controller 212, a controller memory 213, a buffer memory 214, and an Error Correction Code (ECC) circuit 215.

The controller processor 210 may be used to execute the control logic and algorithms of a memory controller, including but not limited to being responsible for address mapping, garbage collection, wear leveling, and other functions. The controller processor 210 may be implemented through an embedded processor or FPGA.

The host interface controller 211 is coupled to the host 108 and the controller processor 210, respectively, and may include a communication interface component between the host and the memory controller, responsible for data transmission between the host and the memory controller, including data reading and writing, and command reception and transmission. It typically supports various interfaces (such as Serial Advanced Technology Attachment (SATA), PCIe) and protocols (such as Advanced Host Controller Interface (AHCI), Non-volatile Memory Express (NVMe)), and provides data transfer functionality.

The flash controller 212 is coupled to the memory device 104 and the controller processor 210, respectively, and may include a communication interface component between the memory device and the memory controller.

The controller memory 213 is coupled to the controller processor 210, and may include a storage area for storing instructions and data. The controller memory 213 may use storage media such as NOR flash, NAND flash, or RAM, etc.

The buffer memory 214 is coupled to the controller processor 210, may include a component for temporarily storing data, and also may be used for caching instructions. It may use high-speed storage devices such as Dynamic Random Access Memory (DRAM) and Static Random Access Memory (SRAM).

The ECC circuit 215 is used for data encoding and decoding, adds ECC checksum protection to data during data write operations, decodes data read from the memory device when reading data, and performs error detection and correction.

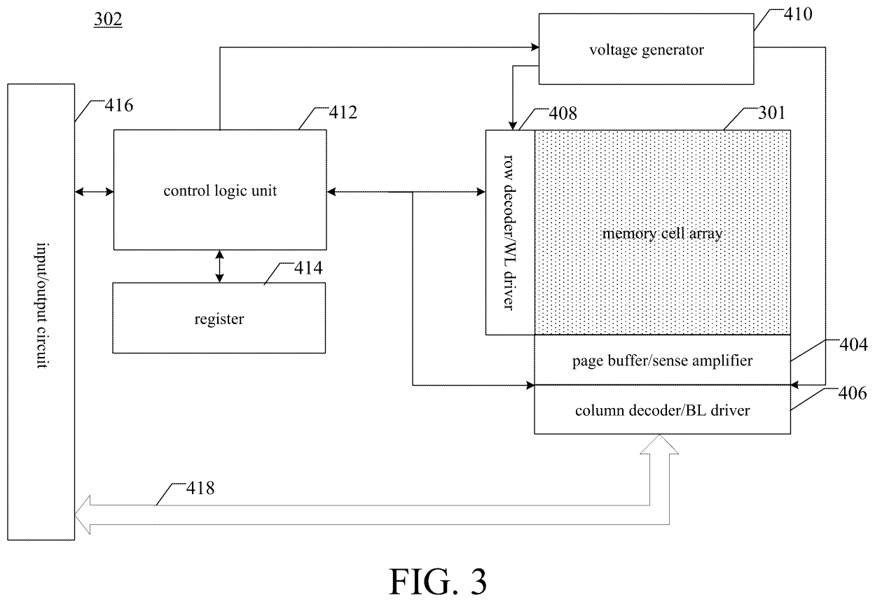

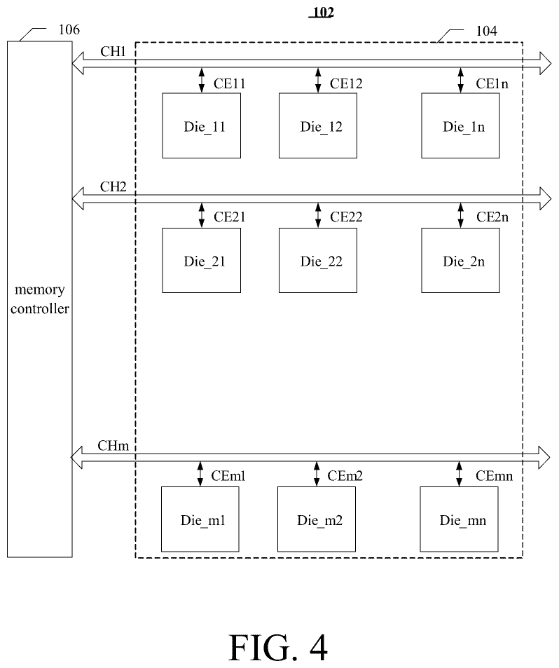

FIG. 3 is a schematic diagram of a peripheral circuit provided in an example of the present disclosure. As shown in FIG. 3, the peripheral circuit 302 may include page buffer/sense amplifier 404, column decoder/bit line (BL) driver 406, row decoder/word line (WL) driver 408, voltage generator 410, control logic unit 412, register 414, input/output (I/O) circuit 416, and data bus 418. It should be understood that in some examples, additional peripheral circuits not shown in FIG. 4 may also be included.

In some examples, the page buffer/sense amplifier 404 may be configured to read data from the memory cell array 301 and program (write) data to the memory cell array 301 based on a control signal from the control logic unit 412. For example, the page buffer/sense amplifier 404 may store a page of programming data (write data) to be programmed into the memory cell array 301. For example, the page buffer/sense amplifier 404 may also sense low-power signals from bit lines representing data bits stored in memory cells, and amplify small voltage swings to recognizable logic levels during read operations. The column decoder/BL driver 406 may be configured to be controlled by the control logic unit 412 and select one or more memory strings by applying bit line voltages generated from the voltage generator 410.

The row decoder/WL driver 408 may be configured to be controlled by the control logic unit 412, and to select/deselect blocks of the memory cell array 301 and select/deselect word lines of the blocks. The row decoder/WL driver 408 may also be configured to use a word line voltage generated from the voltage generator 410 to drive a word line. In some examples, the row decoder/WL driver 408 may also select/deselect and drive source select gate (SSG) and drain select gate (DSG) lines. The voltage generator 410 may be configured to be controlled by the control logic unit 412 and generate a word line voltage (such as read voltage, programming voltage, pass voltage, local voltage, verify voltage, etc.), a bit line voltages, and a source line voltages to be supplied to the memory cell array 301.

The control logic unit 412 may be coupled to each part of the peripheral circuit 302 and configured to control operations of each part. The register 414 may be coupled to the control logic unit 412 and may include status registers, command registers, and address registers for storing status information, command opcodes (OP codes), and command addresses used to control operations of each peripheral circuit. The input/output circuit 416 may be coupled to the control logic unit 412 and serve as a control buffer to buffer control commands received from a host (not shown in FIG. 4) and relay them to the control logic unit 412, and buffer status information received from the control logic unit 412 and relay it to the host. The input/output circuit 416 may also be coupled to the column decoder/bit line driver 406 via the data bus 418, and serve as a data I/O interface and data buffer to buffer data and relay it to the memory cell array 301, or relay or buffer data from the memory cell array 301.

FIG. 4 shows a schematic diagram of an architecture of a memory system in an example of the present disclosure. As shown in FIG. 4, the memory system 102 has one or more memory devices 104 and a memory controller 106. The memory controller 106 is coupled and connected to one or more memory devices 104 through multiple physical channels CH 1, CH 2, . . . , CH m, and sends control commands or transmits data to the memory devices 104. The memory device 104 includes one or more dies (also known as logic units (LUNs)). Each physical channel is connected to one or more dies Die_11, . . . , Die_1n, Die_21, . . . , Die_2n, . . . , Die_m1, . . . , Die_mn. Each chip corresponds to a corresponding chip enable signal (CE) CE11, . . . , CE1n, CE21, . . . , CE2n, . . . , CEm1, . . . , CEmn. A control command sent by the memory controller 106 to the memory device 104 includes the chip enable signal, by which a corresponding die is selected in the physical channel, that is, a target die of the control command is selected.

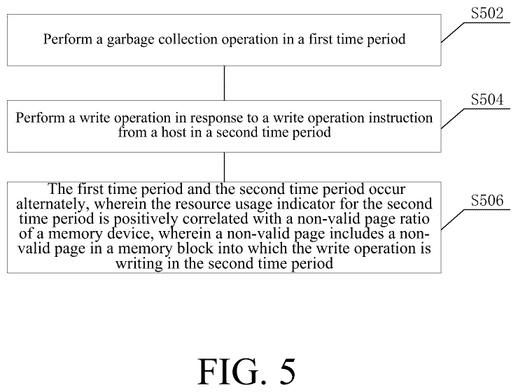

FIG. 5 shows a flowchart of a method for operating a memory system in an example of the present disclosure. In this example, the method for operating the memory system may be executed by a memory controller in the memory system.
As shown in FIG. 5, S502: perform a garbage collection operation in a first time period. In some examples, a resource collection indicator for performing the garbage collection operation in the first time period is a fixed value, and includes a duration for performing the garbage collection operation in the first time period, or includes the count of valid pages collected by performing the garbage collection operation in the first time period.
S504: perform a write operation in response to a write operation instruction from a host in a second time period. In some examples, a resource usage indicator for the second time period includes a duration of the second time period, or includes the amount of data written in the second time period. In some examples, the write operation includes, for example, a random write operation or a sequential write operation.
S506: the first time period and the second time period occur alternately, wherein the resource usage indicator for the second time period is positively correlated with a non-valid page ratio of a memory device, wherein a non-valid page includes a non-valid page in a memory block into which the write operation is writing in the second time period. The garbage collection operation is performed in the first time period, the write operation is performed in the second time period, and operations in the first and second time periods are performed alternately.

In the above example, the garbage collection operation in the first time period and the write operation in the second time period are performed alternately, and the resource usage indicator for the second time period is positively correlated with the non-valid page ratio of the memory device, which may better balance the speed of host-write and the speed of garbage collection. A non-valid page of the memory device includes a non-valid page in a memory block into which the write operation is writing in the second time period, such that the data obtained from the non-valid page may be more accurate and speed adjustment between garbage collection and write operations may be achieved better.

In some examples, the resource collection indicator for performing the garbage collection operation in the first time period includes a duration for performing the garbage collection operation in the first time period, and the resource usage indicator for the second time period includes a duration of the second time period.

In some examples, the resource collection indicator for performing the garbage collection operation in the first time period includes the count of valid pages collected by performing the garbage collection operation in the first time period, and the resource usage indicator for the second time period includes the amount of data written in the second time period.

In some examples, the resource collection indicator for performing the garbage collection operation in the first time period includes a duration for performing the garbage collection operation in the first time period, and the resource usage indicator for the second time period includes the amount of data written in the second time period.

In some examples, the first time period and the second time period occur alternately in sequence, for example, the execution situation presented includes: the first time period, the second time period, the first time period, the second time period, and so on. In some examples, the first time period and the second time period occur alternately, and a third time period may or may not occur between the first and second time periods. A non-garbage collection operation and a non-write operation, such as a read operation or a state fetch operation may be performed in the third time period, and the execution situation presented includes: the first time period, (the third time period), the second time period, (the third time period), the first time period, (the third time period), the second time period, and so on, wherein the third time period is enclosed in parentheses to indicate the third time period may or may not occur. In the above example, other non-write operations may be allowed to be performed in the third time period, which not only achieves speed adjustment between garbage collection and write operation, but also expands usage scenarios and scope, result in the scheme being more flexible and adaptable.

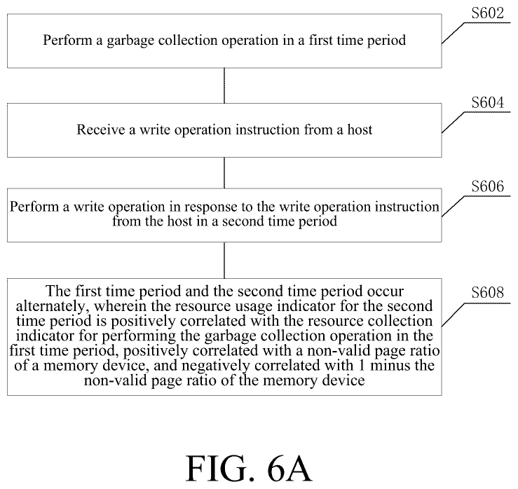

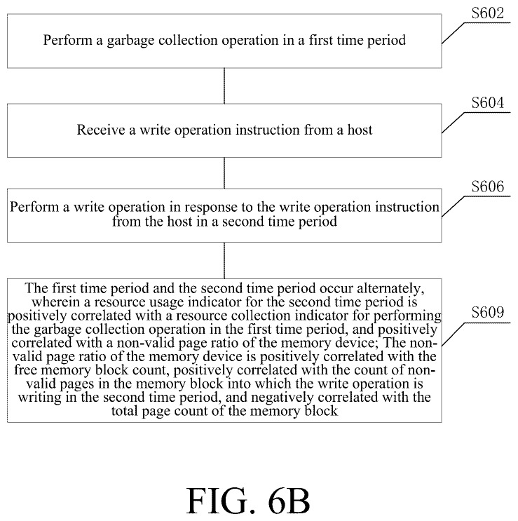

FIG. 6A shows a flowchart of a method for operating a memory system in another example of the present disclosure. In this example, the operating method is executed by a memory controller.
As shown in FIG. 6A, S602: the memory controller may perform a garbage collection operation in a first time period. A resource collection indicator for performing the garbage collection operation in the first time period includes a duration for performing the garbage collection operation in the first time period, or the count of valid pages collected by performing the garbage collection operation in the first time period.
S604: the memory controller may receive a write operation instruction from a host.
S606: the memory controller may perform a write operation in response to the write operation instruction from the host in a second time period. In some examples, a resource usage indicator for the second time period includes a duration of the second time period or the amount of data written in the second time period. The write operation includes a random write operation or a sequential write operation, for example.
S608: the first time period and the second time period occur alternately, wherein the resource usage indicator for the second time period is positively correlated with the resource collection indicator for performing the garbage collection operation in the first time period, positively correlated with a non-valid page ratio of a memory device, and negatively correlated with 1 minus the non-valid page ratio of the memory device. A non-valid page of the memory device includes a non-valid page in a memory block into which the write operation is writing in the second time period.

In the above example, the resource usage indicator for the second time period is positively correlated with the resource collection indicator for performing the garbage collection operation in the first time period, positively correlated with the non-valid page ratio of the memory device, and negatively correlated with 1 minus the non-valid page ratio of the memory device, such that the control of write operations performed in the second time period may be more accurate and speed regulation between garbage collection and write operations may be achieved better.

In some examples, the resource usage indicator I_{HW} for the second time period is determined according to the following equation:

I_{HW}=I_{GC}*R_{v_VB}/(1−R_{v_VB}) (1)

wherein I_{GC} represents the resource collection indicator for performing the garbage collection operation in the first time period, and R_{v_VB} represents the non-valid page ratio of the memory device.

In the above example, a calculation equation for the resource usage indicator for the second time period is provided, which may facilitate obtaining more accurate data for the resource usage indicator and achieve a better balance between garbage collection and write operations.

FIG. 6B shows a flowchart of a method of operating a memory system in yet another example of the present disclosure.
As shown in FIG. 6B, S602: the memory controller performs a garbage collection operation in a first time period.
S604: the memory controller receives a write operation instruction from a host.
S606: the memory controller performs a write operation in response to the write operation instruction from the host in the second time period.
S609: the first time period and the second time period occur alternately, wherein a resource usage indicator for the second time period is positively correlated with a resource collection indicator for performing the garbage collection operation in the first time period, and positively correlated with a non-valid page ratio of the memory device, wherein a non-valid page of the memory device includes a non-valid pages in a memory block into which the write operation is writing in the second time period. The non-valid page ratio of the memory device is positively correlated with the free memory block count, positively correlated with the count of non-valid pages in the memory block into which the write operation is writing in the second time period, and negatively correlated with the total page count of the memory block.

In the above example, the non-valid page ratio of the memory device is positively correlated with the free memory block count, positively correlated with the count of non-valid pages in the memory block into which the write operation is writing in the second time period, and negatively correlated with the total page count of the memory block, which may result in an accurate calculation of the non-valid page ratio of the memory device, thereby determining the resource usage indicator for the second time period more accurately and achieving a better balance between garbage collection and write operations.

In some examples, the non-valid page ratio of the memory device is determined according to the following equation:

R_{v_VB}=(C_{free_VB}−5)*20+NVPC_{open_VB}/(TPCₜₒₜₐₗ/20) (2)

wherein C_{free_VB} represents the free memory block count, NVPC_{open_VB} represents the count of non-valid pages in the memory block into which the write operation is writing in the second time period, and TPCₜₒₜₐₗ represents the total page count of the memory block.

In the above example, a calculation equation for the non-valid page ratio of the memory device is provided, which may facilitate more accurately calculating the non-valid page ratio of the memory device, thereby achieving a better balance between garbage collection and write operations.

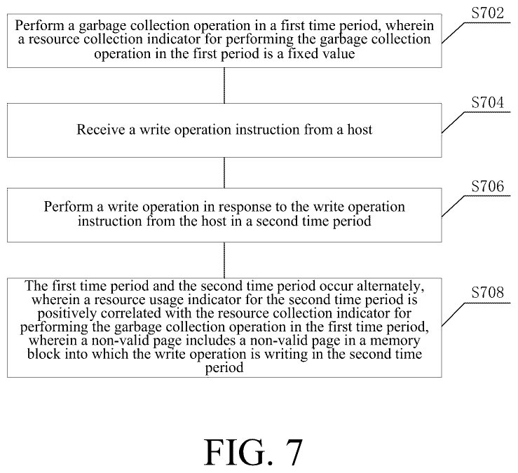

FIG. 7 shows a flowchart of a method for operating a memory system in yet another example of the present disclosure.
As shown in FIG. 7, S702: the memory controller performs a garbage collection operation in a first time period. A resource collection indicator for performing the garbage collection operation in the first period is a fixed value.
S704: the memory controller receives a write operation instruction from a host.
S706: the memory controller performs a write operation in response to the write operation instruction from the host in a second time period.
S708: the first time period and the second time period occur alternately, wherein a resource usage indicator for the second time period is positively correlated with the resource collection indicator for performing the garbage collection operation in the first time period. A non-valid page of the memory device includes a non-valid page in a memory block into which the write operation is writing in the second time period.

It should be noted that the resource usage indicator for the second time period may be determined according to the methods described in the previous examples.

In the above example, the resource collection indicator for performing the garbage collection operation in the first time period is a fixed value, which may better control the garbage collection operation and more conveniently and quickly determine the resource usage indicator for the second time period, thereby better controlling the entire process.

In some examples, the resource collection indicator for performing the garbage collection operation in the first time period includes a duration of performing the garbage collection operation, which is a fixed value, such as 20-50 milliseconds.

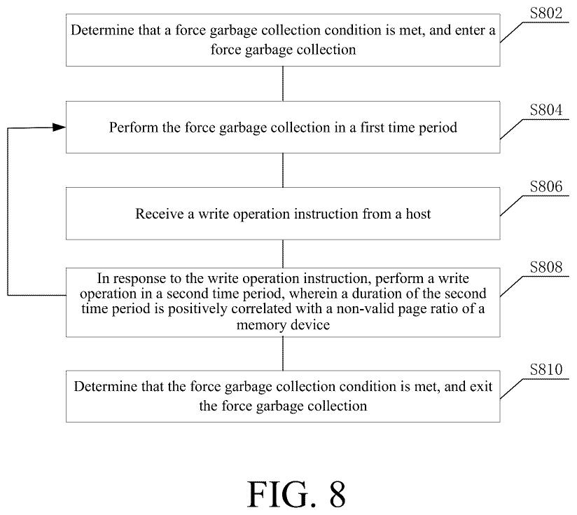

FIG. 8 shows a flowchart of a method for operating a memory system in yet another example of the present disclosure.
As shown in FIG. 8, S802: the memory controller determines that a force garbage collection condition is met and enters a force garbage collection. In some examples, the force garbage collection condition includes: the free memory block count of the memory system is less than a first set threshold and greater than a second set threshold. In some examples, the first set threshold may be 9, 10, 11, or 12, and the second set threshold may be 4, 5, or 6.
S804: the memory controller performs the force garbage collection in a first time period.
S806: the memory controller receives a write operation instruction from a host.
S808: in response to the write operation instruction, perform a write operation in a second time period, wherein a duration of the second time period is positively correlated with a non-valid page ratio of the memory device, wherein S804-S808 are executed in cycles until it is determined that the force garbage collection condition is met, and then the force garbage collection is exited (S810).

In the above example, the memory control first determines that the force garbage collection condition is met, and then performs operations in the first and second time periods, thereby better achieving operations of the force garbage collection stage and achieving speed regulation gearing.

In some examples, the second set threshold is used as a threshold for speed regulation gearing, and the first set threshold is greater than the second set threshold. The second set threshold is determined according to the requirements of speed regulation gearing. That is, when the free memory block count of the memory system is less than the second set threshold, an emergency garbage collection stage is entered. Generally, the second set threshold is greater than or equal to 4. The first set threshold is increased by a certain amount on the basis of the second set threshold, such as 4, 5, or 6.

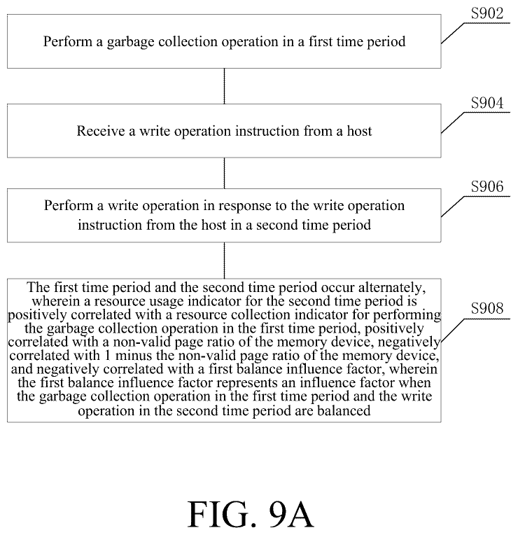

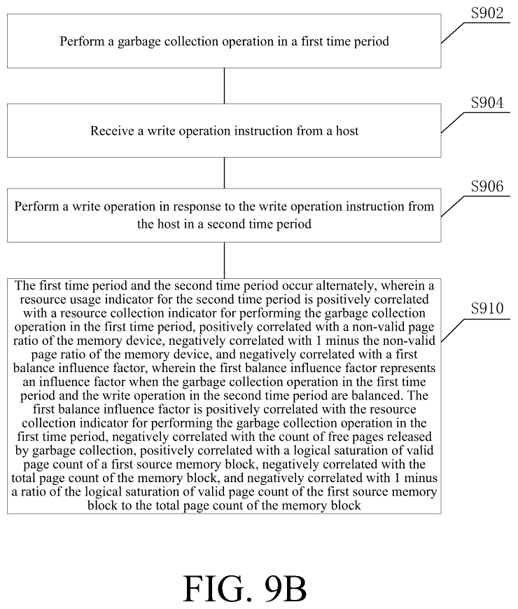

FIG. 9A shows a flowchart of a method for operating a memory system in yet another example of the present disclosure.
As shown in FIG. 9A, S902: the memory controller performs a garbage collection operation in a first time period.
S904: the memory controller receives a write operation instruction from a host.
S906: the memory controller performs a write operation in response to the write operation instruction from the host in a second time period.
S908: the first time period and the second time period occur alternately, wherein a resource usage indicator for the second time period is positively correlated with a resource collection indicator for performing the garbage collection operation in the first time period, positively correlated with a non-valid page ratio of the memory device, negatively correlated with 1 minus the non-valid page ratio of the memory device, and negatively correlated with a first balance influence factor, wherein the first balance influence factor represents an influence factor when the garbage collection operation in the first time period and the write operation in the second time period are balanced.

In the above example, the determining of the resource usage indicator for the second time period introduces a first balance influence factor, thereby facilitating more accurately determining the resource usage indicator for the second time period and achieving a better balance between garbage collection operations and write operations.

In some examples, the resource usage indicator IHW for the second time period is determined according to the following equation:

I_{HW}=I_{GC}*R_{v_VB}/(1−R_{v_VB})/VpcFactor (3)

wherein I_{GC} represents the resource collection indicator for performing the garbage collection operation in the first time period, R_{v_VB} represents the non-valid page ratio of the memory device, and VpcFactor represents the first balance influence factor.

In the above example, a calculation equation for the resource usage indicator for the second time period is provided, and includes the first balance influence factor, so that the non-valid page ratio of the memory device may be calculated more accurately, thereby achieving a better balance between garbage collection and write operations.

FIG. 9B shows a flowchart of a method for operating a memory system in yet another example of the present disclosure.
As shown in FIG. 9B, S902: the memory controller performs a garbage collection operation in a first time period.
S904: the memory controller receives a write operation instruction from a host.
S906: the memory controller performs a write operation in response to the write operation instruction from the host in a second time period.
S910: the first time period and the second time period occur alternately, wherein a resource usage indicator for the second time period is positively correlated with a resource collection indicator for performing the garbage collection operation in the first time period, positively correlated with a non-valid page ratio of the memory device, negatively correlated with 1 minus the non-valid page ratio of the memory device, and negatively correlated with a first balance influence factor, wherein the first balance influence factor represents an influence factor when the garbage collection operation in the first time period and the write operation in the second time period are balanced. The first balance influence factor is positively correlated with the resource collection indicator for performing the garbage collection operation in the first time period, negatively correlated with the count of free pages released by garbage collection, positively correlated with a logical saturation of valid page count of a first source memory block, negatively correlated with the total page count of the memory block, and negatively correlated with 1 minus a ratio of the logical saturation of valid page count of the first source memory block to the total page count of the memory block.

In the above example, specific factors related to the first balance influence factor are provided, which may facilitate more accurately determining the first balance influence factor and thus more accurately determining the resource usage indicator for the second time period, achieving a better balance between garbage collection and write operations.

In some examples, the first influence factor VpcFactor is determined according to the following equation:

VpcFactor=(I_{GC}*30/70)*(100−VpcRatio)/(gc_pu_count*VpcRatio) (4)

VpcRatio=100−(S_{SSVB_VPC}/TPCₜₒₜₐₗ)*100 (5)

wherein gc_pu_count represents the count of free pages released by garbage collection, TPCₜₒₜₐₗ represents the total page count of the memory block, and S_{SSVB_VPC} represents the logical saturation of valid page count of the first source memory block, wherein the first source memory block is a source memory block having a second logical saturation of valid page count in the logical saturations of valid page counts of the source memory blocks.

In the above example, a calculation equation for the first influence factor is provided, which may facilitate more accurately calculating the first influence factor and achieving a better balance between garbage collection and write operations.

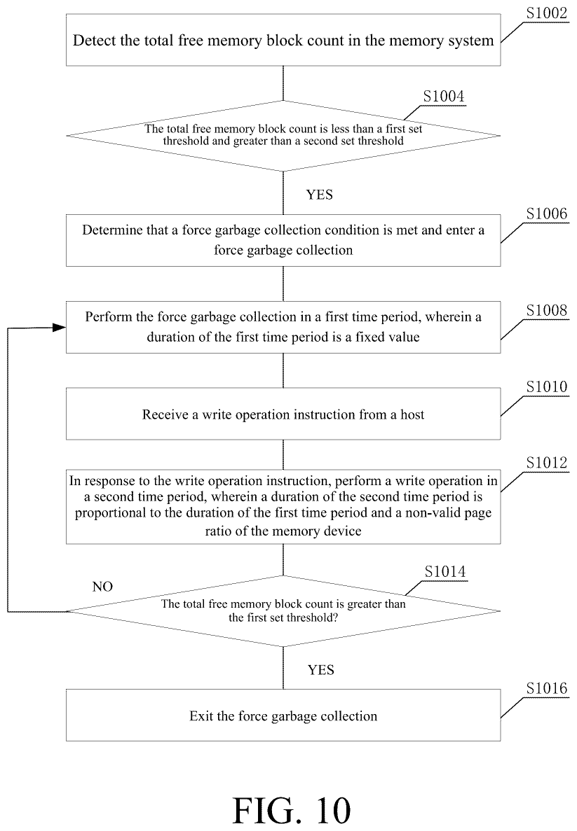

FIG. 10 shows a flowchart of a method for operating a memory system in yet another example of the present disclosure.
As shown in FIG. 10, S1002: detect the total free memory block count in the memory system.
S1004: determine whether the total free memory block count is less than a first set threshold and greater than a second set threshold. If yes, continue with S1006.
S1006: determine that a force garbage collection condition is met and enter a force garbage collection.
S1008: perform the force garbage collection in a first time period, wherein a duration of the first time period is a fixed value.
S1010: receive a write operation instruction from a host.
S1012: in response to the write operation instruction, perform a write operation in a second time period, wherein a duration of the second time period is proportional to the duration of the first time period and a non-valid page ratio of the memory device.
S1014: determine whether the total free memory block count is greater than the first set threshold. If not, continue with S1008; otherwise, continue with S1016.
S1016: exit the force garbage collection.

In the above example, by detecting the total free memory block count in the system, it is determined whether the force garbage collection condition is met. When it is met, the garbage collection operation in the first time period and the write operation in the second time period are performed alternately, thereby achieving speed regulation gearing and optimization of system performance, and improving the dirty data performance and IO latency performance of the memory system.

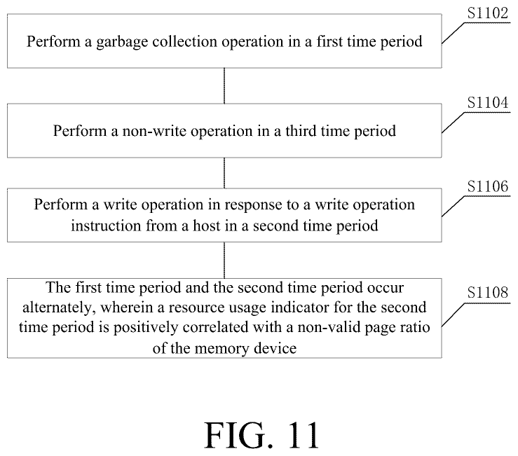

FIG. 11 shows a flowchart of a method for operating a memory system in yet another example of the present disclosure.
As shown in FIG. 11, S1102: the memory controller performs a garbage collection operation in a first time period.
S1104: the memory controller performs a non-write operation, such as a read operation or a state fetch operation in a third time period.
S1106: the memory controller performs a write operation in response to a write operation instruction from a host in a second time period.
S1108: the first time period and the second time period occur alternately, wherein a resource usage indicator for the second time period is positively correlated with a non-valid page ratio of the memory device, wherein a non-valid page includes a non-valid page in a memory block into which the write operation is writing in the second time period. The garbage collection operation is performed in the first time period, the write operation is performed in the second time period, and operations in the first and second time periods are performed alternately.

In the above example, the third time period is performed between the first time period and the second time period, and a non-write operation is performed in the third time period, which not only achieves speed adjustment between garbage collection and write operations, but also expands the usage scenarios and scope, result in the scheme being more flexible and adaptable.

In a technical solution, the algorithm for the force garbage collection (FGC) is as follows: for garbage collection every 30 ms, a host writes (HW) Interval:

HW Interval=(1−VPC saturation of the first source memory block)*30*PU*DN (6)

wherein the first source memory block represents a source memory block having a second logical saturation of valid page count in the logical saturations of valid page counts of the source memory blocks, PU represents a programming unit, and DN (Die Number) represents the count of dies.

Taking TLC (triple-level cell) as an example, PU is an amount Z of TLC, for example, 72*4 kilobytes (KB).

For DN, taking SDP (single-die package) as an example, the value of DN is 1; taking DDP (dual-die package) as an example, the value of DN is 2; taking QDP (quad-die package) as an example, the value of DN is 4.

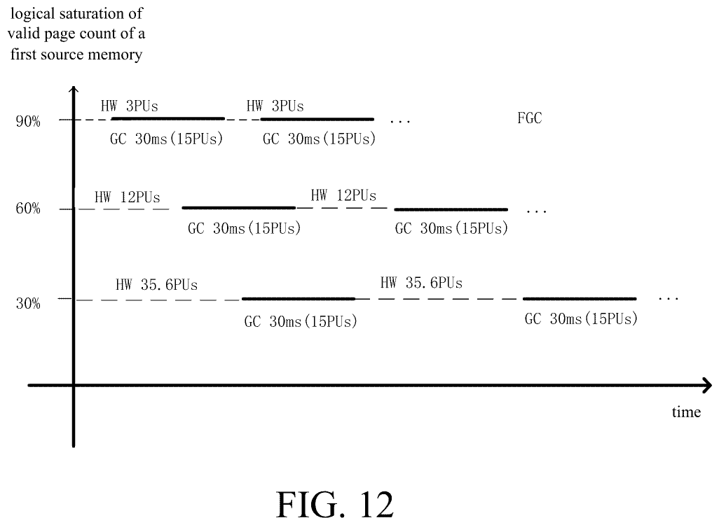

FIG. 12 shows a schematic diagram of a force garbage collection over time under different VPC logic saturations of a first source memory block. During the force garbage collection, approximately 15 PUs are moved from the source memory block to the target memory block every 30 milliseconds (ms) of GC. The amount of data written by the host depends on the source memory block having a second logical saturation of valid page count of the logical saturations of valid page counts, as shown in FIG. 12, The higher the VPC logic saturation of the source memory block having a second VPC logic saturation in VPC logic saturations is, the less data the host may write.

An application example of the technical solution in examples of the present disclosure is described below.

In this application example, it is assumed that the first set threshold is 10 and the second set threshold is 5. The total free memory block count at the force garbage collection interval is 5 (e.g., memory blocks 10, 9, 8, 7, 6), and 5 free memory blocks are divided into 100 parts, with each part having a storage space equal to the total number of pages per memory block/20, e.g., the total Page Count per memory block (e.g., VB)/20. Then, by applying the technical solution of the present disclosure, write performance of the host will not experience a cliff like decline, but will gradually change with the decrease or increase in the count of non-valid pages. The faster the garbage collection releases memory blocks, the more non-valid pages may be, and the less write performance of the host decreases, the slower the garbage collection releases memory blocks, the fewer non-valid pages are, and the more write performance of the host decreases.

In some examples, it includes the following:
1. In an FGC stage, the way for alternating operations between Host-write and GC interval is adopted. The execution time/interval of GC per cycle may be selected as a constant value, such as 30. The execution time/interval of HW per cycle is dynamically adjusted according to a free size ratio, wherein the execution time of HW per cycle and the non-valid page ratio satisfy a preset functional relationship: according to:

HW Interval/(HW Interval/max speed+GC Interval/max speed)=(free size ratio/100)*max speed (7)

derive:

HW Interval=(GC Interval*free size ratio/(100−free size ratio)) (8)

For example, for every HW interval written by the host, 30*nWay is selected as a constant value of the GC interval; nWay is 1, 2, and 4 corresponding to SDP, DDP, and QDP.

The total free memory blocks of the FGC interval (e.g., 5 memory blocks, 10, 9, 8, 7, 6 in total) are divided into 100 parts, with each part having an amount of TPCₜₒₜₐₗ/20, wherein TPCₜₒₜₐₗ represents the total page count of the memory block.

free size ratio=(C_{free_VB}−5)*20+NVPC_{open_VB}/(TPCₜₒₜₐₗ/20) (9)

wherein C_{free_VB} represents the current available free block count, e.g., the free memory block count, NVPC_{open_VB} represents the count of non-valid pages in the memory block into which the write operation is writing in the second time period, and TPCₜₒₜₐₗ represents the total page count of the memory block.

HW Interval=(30*nWay*free size ratio/(100−free size ratio)) (10)
2. When the free size ratio is 30% and the host-write and garbage collection operations reach a balance: HW Interval=30*30*nWay/(100−30)=13*nWay

VpcRatio=100−(S_{SSVB_VPC}/TPCₜₒₜₐₗ)*100 (11)

wherein S_{SSVB_VPC} represents the logical saturation of valid page count of the first source memory block, wherein the first source memory block is a source memory block having a second logical saturation of valid page count in the logical saturations of valid page counts of the source memory blocks.

### According to:

VpcRatio/(100−VpcRatio)=(13*nWay/VpcFactor)/gc_pu_count (12)

wherein gc_pu_comunt represents the count of free pages released by garbage collection, derive:

VpcFactor=13*nWay*(100−VpcRatio)/(gc_pu_count*VpcRatio) (13)
3.Host-write:

Hw Interval=HW Interval/VpcFactor (14)

In examples of the present disclosure, a way for alternating operations between host-write operations and garbage collection operations is adopted, and the execution time/interval of garbage collection operations per cycle may be selected as a constant value, such as 30 ms. The execution time/interval of HW per cycle is dynamically adjusted according to the non-valid page ratio. In some examples, the optimization execution strategy is executed during the force garbage collection stage. In this way, the performance of write operations of the memory system (including sequential writes and random writes, SW/RW) will not experience a cliff like decline, and the fluctuation amplitude of the system will be significantly improved; Moreover, the overall IO latency of the memory system will be significantly improved.

In an illustrated example, a computer-readable storage medium comprising instructions is also provided, such as a controller memory comprising instructions, and when executed by a controller processor of the memory controller, the above instructions may accomplish the above methods. In some examples, the computer-readable storage medium may include read-only memory (ROM), random access memory (RAM), compact disc ROM (CD-ROM), magnetic tape, floppy disk, and optical data storage devices, etc.

In an illustrated example, a computer program product is also provided, comprising a computer program/instruction that, when executed by a processor, implements the methods described in the above examples.

It should be understood that the term “some examples” mentioned throughout the specification means that specific features, structures, or characteristics related to the examples are included in at least one example of the present disclosure. Therefore, the phrases “in some examples” or “in some other examples” that appear throughout the entire specification may not necessarily refer to the same examples. In addition, these specific features, structures, or characteristics may be combined in any suitable manner in one or more examples. It should be understood that in various examples of the present disclosure, the size of the sequence numbers of the above processes does not imply the order of execution. The order of execution of each process should be determined by its function and internal logic, and should not constitute any limitation on the implementation process of examples of the present disclosure. The above serial number of examples of the present disclosure are for description only and do not represent the advantage or disadvantages of the examples.

It should be noted that, the terms “including”, “comprising”, or any other variation thereof herein are intended to encompass non-exclusive inclusion, such that a process, method, article, or apparatus that includes a series of elements not only includes those elements, but also includes other elements not explicitly listed, or also includes elements inherent to such process, method, article, or apparatus. Without further limitations, the element limited by the statement ‘including one...’ does not exclude the existence of other identical elements in the process, method, article, or apparatus that includes the element.

In several examples provided in the present disclosure, it should be understood that the disclosed devices and methods may be implemented in other ways. The device examples described above are only illustrative. For example, the division of units is only a logical functional division. In practical implementations, there may be other division methods, such as multiple units or components may be combined, integrated into another system, or some features may be ignored or not executed. In addition, the coupling, direct coupling, or communication connection between various components displayed or discussed may be indirect coupling or communication connection through some interfaces, devices, or units, which may be electrical, mechanical, or other forms.

The units described above as separate components may or may not be physically separated, and the components displayed as units may or may not be physical units, may be located in one place or distributed across multiple network units. Some or all of the units may be selected according to actual needs to achieve the purpose of the solution of this example.

In addition, all functional units in examples of the present disclosure may be integrated into one processing unit, or each unit may be treated as a separate unit, or two or more units may be integrated into one unit. The above integrated units may be implemented in the form of hardware or in the form of hardware and software functional units.

Examples of the present disclosure provide a memory system, a memory controller, an operating method, a computer-readable storage medium, and a computer program product.

According to one aspect of examples of the present disclosure, a memory system is provided, comprising: a memory controller; and a memory device coupled to the memory controller, wherein the memory controller is configured to: perform a garbage collection operation in a first time period; and perform a write operation in response to a write operation instruction from a host in a second time period, wherein the first time period and the second time period occur alternately, and a resource usage indicator for the second time period is positively correlated with a non-valid page ratio of the memory device, wherein a non-valid page includes a non-valid page in a memory block into which the write operation is writing in the second time period.

In some examples, the resource usage indicator for the second time period includes a duration of the second time period.

In some examples, the resource usage indicator for the second time period includes the amount of data written in the second time period.

In some examples, the resource usage indicator for the second time period is positively correlated with a resource collection indicator for performing the garbage collection operation in the first time period, positively correlated with the non-valid page ratio of the memory device, and negatively correlated with 1 minus the non-valid page ratio of the memory device.

In some examples, the resource collection indicator for performing the garbage collection operation in the first time period includes a duration for performing the garbage collection operation in the first time period.

In some examples, the resource collection indicator for performing the garbage collection operation in the first time period includes the count of valid pages collected by performing the garbage collection operation in the first time period.

In some examples, the resource usage indicator I_{HW} for the second time period is determined according to the following equation:

I_{HW}=I_{GC}*R_{v_VB}/(1−R_{v_VB})

wherein I_{GC} represents the resource collection indicator for performing the garbage collection operation in the first time period, and R_{v_VB} represents the non-valid page ratio of the memory device.

In some examples, the non-valid page ratio of the memory device is positively correlated with the free memory block count, positively correlated with the count of non-valid pages in the memory block into which the write operation is writing in the second time period, and negatively correlated with the total page count of the memory block.

In some examples, the non-valid page ratio of the memory device is determined according to the following equation:

R_{v_VB}==(C_{free_VB}−5)*20+NVPC_{open_VB}/(TPCₜₒₜₐₗ/20)

wherein C_{free_VB} represents the free memory block count, NVPC_{open_VB} represents the count of non-valid pages in the memory block into which the write operation is writing in the second time period, and TPCₜₒₜₐₗ represents the total page count of the memory block.

In some examples, the memory controller is further configured to: determine that the memory system meets a force garbage collection condition.

In some examples, the force garbage collection condition comprises: the free memory block count of the memory system is less than a first set threshold and greater than a second set threshold.

In some examples, the first set threshold is 9, 10, 11 or 12, and the second set threshold is 4, 5 or 6.

In some examples, the second set threshold is a threshold for speed regulation gearing, and the first set threshold is greater than the second set threshold.

In some examples, a resource collection indicator for performing the garbage collection operation in the first time period is a fixed value.

In some examples, the memory controller is further configured to: perform an operation in a third time period between the first time period and the second time period, wherein the operation in the third time period includes a non-write operation.

In some examples, the resource collection indicator for performing the garbage collection operation in the first time period includes a duration for performing the garbage collection operation in the first time period, and the duration for performing the garbage collection operation in the first time period includes 20-50 milliseconds.

In some examples, the resource usage indicator for the second time period is positively correlated with the resource collection indicator for performing the garbage collection operation in the first time period, positively correlated with the non-valid page ratio of the memory device, negatively correlated with 1 minus the non-valid page ratio of the memory device, and negatively correlated with a first balance influence factor, wherein the first balance influence factor represents an influence factor when the garbage collection operation in the first time period and the write operation in the second time period are balanced.

In some examples, the resource usage indicator I_{HW} for the second time period is determined according to the following equation:

I_{HW}=I_{GC}*R_{v_VB}/(1−R_{v_VB})/VpcFactor

wherein IGC represents the resource collection indicator for performing the garbage collection operation in the first time period, Rv_VB represents the non-valid page ratio of the memory device, and VpcFactor represents the first balance influence factor.

In some examples, the first balance influence factor is positively correlated with the resource collection indicator for performing the garbage collection operation in the first time period, negatively correlated with the count of free pages released by garbage collection, positively correlated with a logical saturation of valid page count of a first source memory block, negatively correlated with the total page count of the memory block, and negatively correlated with 1 minus a ratio of the logical saturation of valid page count of the first source memory block to the total page count of the memory block.

In some examples, the first influence factor VpcFactor is determined according to the following equation:

VpcFactor=(I_{GC}*30/70)*(100−VpcRatio)/(gc_pu_count*VpcRatio)

VpcRatio=100−(S_{SSVB_VPC}/TPCₜₒₜₐₗ)*100

wherein gc_pu_count represents the count of free pages released by the garbage collection, TPCₜₒₜₐₗ represents the total page count of the memory block, and S_{SSVB_VPC} represents the logical saturation of valid page count of the first source memory block, wherein the first source memory block is a source memory block having a second logical saturation of valid page count in the logical saturations of valid page counts of the source memory blocks.

According to another aspect of the present disclosure, a memory controller is provided, comprising: a controller memory configured to store control instructions; and a controller processor coupled to the controller memory and configured to execute the control instructions to perform processing comprising: performing a garbage collection (GC) operation in a first time period; and performing a write operation in response to a write operation instruction from a host in a second time period, wherein the first time period and the second time period occur alternately, and a resource usage indicator for the second time period is positively correlated with a non-valid page ratio of a memory device, wherein a non-valid page includes a non-valid page in a memory block into which the write operation is writing in the second time period.

In some examples, the resource usage indicator for the second time period includes a duration of the second time period.

In some examples, the resource usage indicator for the second time period includes the amount of data written in the second time period.

In some examples, the resource usage indicator for the second time period is positively correlated with a resource collection indicator for performing the garbage collection operation in the first time period, positively correlated with the non-valid page ratio of the memory device, and negatively correlated with 1 minus the non-valid page ratio of the memory device.

In some examples, the resource collection indicator for performing the garbage collection operation in the first time period includes a duration for performing the garbage collection operation in the first time period.

In some examples, the resource collection indicator for performing the garbage collection operation in the first time period includes the count of valid pages collected by performing the garbage collection operation in the first time period.

In some examples, the resource usage indicator IHW for the second time period is determined according to the following equation:

I_{HW}=I_{GC}*R_{v_VB}/(1−R_{v_VB})

wherein I_{GC} represents the resource collection indicator for performing the garbage collection operation in the first time period, and R_{v_VB} represents the non-valid page ratio of the memory device.

In some examples, the non-valid page ratio of the memory device is positively correlated with the free memory block count, positively correlated with the count of non-valid pages in the memory block into which the write operation is writing in the second time period, and negatively correlated with the total page count of the memory block.

In some examples, the non-valid page ratio of the memory device is determined according to the following equation:

R_{v_VB}==(C_{free_VB}−5)*20+NVPC_{open_VB}/(TPCₜₒₜₐₗ/20)

wherein C_{free_VB} represents the free memory block count, NVPC_{open_VB} represents the count of non-valid pages in the memory block into which the write operation is writing in the second time period, and TPCₜₒₜₐₗ represents the total page count of the memory block.

In some examples, the processing further comprises: determining that a memory system meets a force garbage collection condition.

In some examples, the force garbage collection condition comprises: the free memory block count of the memory system is less than a first set threshold and greater than a second set threshold.

In some examples, the first set threshold is 9, 10, 11 or 12, and the second set threshold is 4, 5 or 6.

In some examples, the second set threshold is a threshold for speed regulation gearing, and the first set threshold is greater than the second set threshold.

In some examples, a resource collection indicator for performing the garbage collection operation in the first time period is a fixed value.

In some examples, the processing further comprises: performing an operation in a third time period between the first time period and the second time period, wherein the operation in the third time period includes a non-write operation.

In some examples, the resource collection indicator for performing the garbage collection operation in the first time period includes a duration for performing the garbage collection operation in the first time period, and the duration for performing the garbage collection operation in the first time period includes 20-50 milliseconds.

In some examples, the resource usage indicator for the second time period is positively correlated with the resource collection indicator for performing the garbage collection operation in the first time period, positively correlated with the non-valid page ratio of the memory device, negatively correlated with 1 minus the non-valid page ratio of the memory device, and negatively correlated with a first balance influence factor, wherein the first balance influence factor represents an influence factor when the garbage collection operation in the first time period and the write operation in the second time period are balanced.

In some examples, the resource usage indicator I_{HW} for the second time period is determined according to the following equation:

I_{HW}=I_{GC}*R_{v_VB}/(1−R_{v_VB})/VpcFactor

wherein I_{GC} represents the resource collection indicator for performing the garbage collection operation in the first time period, R_{v_VB} represents the non-valid page ratio of the memory device, and VpcFactor represents the first balance influence factor.

In some examples, the first balance influence factor is positively correlated with the resource collection indicator for performing the garbage collection operation in the first time period, negatively correlated with the count of free pages released by garbage collection, positively correlated with a logical saturation of valid page count of a first source memory block, negatively correlated with the total page count of the memory block, and negatively correlated with 1 minus a ratio of the logical saturation of valid page count of the first source memory block to the total page count of the memory block.

In some examples, the first influence factor VpcFactor is determined according to the following equation:

VpcFactor=(I_{GC}*30/70)*(100−VpcRatio)/(gc_pu_count*VpcRatio)

VpcRatio=100−(S_{SSVB_VPC}/TPCₜₒₜₐₗ)*100

wherein gc_pu_count represents the count of free pages released by the garbage collection, TPCₜₒₜₐₗ represents the total page count of the memory block, and S_{SSVB_VPC} represents the logical saturation of valid page count of the first source memory block, wherein the first source memory block is a source memory block having a second logical saturation of valid page count in the logical saturations of valid page counts of the source memory blocks.

According to yet another aspect of the present disclosure, a method for operating a memory system applied to a memory controller is provided, the method comprising: performing a garbage collection (GC) operation in a first time period; and performing a write operation in response to a write operation instruction from a host in a second time period, wherein the first time period and the second time period occur alternately, and a resource usage indicator for the second time period is positively correlated with a non-valid page ratio of a memory device, wherein a non-valid page includes a non-valid page in a memory block into which the write operation is writing in the second time period.

In some examples, the resource usage indicator for the second time period includes a duration of the second time period.

In some examples, the resource usage indicator for the second time period includes the amount of data written in the second time period.

In some examples, the resource usage indicator for the second time period is positively correlated with a resource collection indicator for performing the garbage collection operation in the first time period, positively correlated with the non-valid page ratio of the memory device, and negatively correlated with 1 minus the non-valid page ratio of the memory device.

In some examples, the resource collection indicator for performing the garbage collection operation in the first time period includes a duration for performing the garbage collection operation in the first time period.

In some examples, the resource collection indicator for performing the garbage collection operation in the first time period includes the count of valid pages collected by performing the garbage collection operation in the first time period.

In some examples, the resource usage indicator I_{HW} for the second time period is determined according to the following equation:

I_{HW}=I_{GC}*R_{v_VB}/(1−R_{v_VB})

wherein I_{GC} represents the resource collection indicator for performing the garbage collection operation in the first time period, and R_{v_VB} represents the non-valid page ratio of the memory device.

In some examples, the non-valid page ratio of the memory device is positively correlated with the free memory block count, positively correlated with the count of non-valid pages in the memory block into which the write operation is writing in the second time period, and negatively correlated with the total page count of the memory block.

In some examples, the non-valid page ratio of the memory device is determined according to the following equation:

R_{v_VB}==(C_{free_VB}−5)*20+NVPC_{open_VB}/(TPCₜₒₜₐₗ/20)

wherein C_{free_VB} represents the free memory block count, NVPC_{open_VB} represents the count of non-valid pages in the memory block into which the write operation is writing in the second time period, and TPCₜₒₜₐₗ represents the total page count of the memory block.

In some examples, the method further comprises: determining that the memory system meets a force garbage collection condition.

In some examples, the force garbage collection condition comprises: the total free memory block count of the memory system is less than a first set threshold and greater than a second set threshold.

In some examples, the first set threshold is 9, 10, 11 or 12, and the second set threshold is 4, 5 or 6.

In some examples, the second set threshold is a threshold for speed regulation gearing, and the first set threshold is greater than the second set threshold.

In some examples, a resource collection indicator for performing the garbage collection operation in the first time period is a fixed value.

In some examples, the method further comprises: performing an operation in a third time period between the first time period and the second time period, wherein the operation in the third time period includes a non-write operation.

In some examples, the resource collection indicator for performing the garbage collection operation in the first time period includes a duration for performing the garbage collection operation in the first time period, and the duration for performing the garbage collection operation in the first time period includes 20-50 milliseconds.

In some examples, the resource usage indicator for the second time period is positively correlated with the resource collection indicator for performing the garbage collection operation in the first time period, positively correlated with the non-valid page ratio of the memory device, negatively correlated with 1 minus the non-valid page ratio of the memory device, and negatively correlated with a first balance influence factor, wherein the first balance influence factor represents an influence factor when the garbage collection operation in the first time period and the write operation in the second time period are balanced.

In some examples, the resource usage indicator I_{HW} for the second time period is determined according to the following equation:

I_{HW}=I_{GC}*R_{v_VB}/(1−R_{v_VB})/VpcFactor

wherein I_{GC} represents the resource collection indicator for performing the garbage collection operation in the first time period, R_{v_VB} represents the non-valid page ratio of the memory device, and VpcFactor represents the first balance influence factor.

In some examples, the first balance influence factor is positively correlated with the resource collection indicator for performing the garbage collection operation in the first time period, negatively correlated with the count of free pages released by garbage collection, positively correlated with a logical saturation of valid page count of a first source memory block, negatively correlated with the total page count of the memory block, and negatively correlated with 1 minus a ratio of the logical saturation of valid page count of the first source memory block to the total page count of the memory block.

In some examples, the first influence factor VpcFactor is determined according to the following equation:

VpcFactor=(I_{GC}*30/70)*(100−VpcRatio)/(gc_pu_count*VpcRatio)

VpcRatio=100−(S_{SSVB_VPC}/TPCₜₒₜₐₗ)*100

wherein gc_pu_count represents the count of free pages released by the garbage collection, TPCₜₒₜₐₗ represents the total page count of the memory block, and S_{SSVB_VPC} represents the logical saturation of valid page count of the first source memory block, wherein the first source memory block is a source memory block having a second logical saturation of valid page count in the logical saturations of valid page counts of the source memory blocks.

According to yet another aspect of the present disclosure, a computer-readable storage medium is provided. When control instructions in the computer-readable storage medium are executed by a controller processor, the controller processor is caused to perform the operating method described above.

According to yet another aspect of the present disclosure, a computer program product is provided, comprising a computer program/instruction, wherein the computer program/instruction, when executed by a processor, implements the operating method described above.

A memory system, a memory controller, an operating method, a computer-readable storage medium, and a computer program product of the present disclosure performs a garbage collection operation in the first time period and a writing operation in the second time period alternately, and a resource usage indicator for the second time period is positively correlated with the non-valid page ratio of the memory device, a non-valid page of the memory device includes a non-valid page in a memory block into which the write operation is writing in the second time period, so that the data obtained from the non-valid page is more accurate, and the speed of host-write and the speed of garbage collection may be better balanced.

It should be understood that the above general description and the detailed description are only example and explanatory, and cannot limit the present disclosure.

The above are only implementations of the present disclosure, but the scope of the present disclosure is not limited to this. Any skilled in the art may easily think of changes or replacements within the technical scope of the present disclosure, which should be included in the scope of the present disclosure. Therefore, the scope of the present disclosure should be based on the scope of the claims.

What is claimed is:

1. A memory system comprising:
a memory controller; and
a memory device coupled to the memory controller, the memory controller configured to:
perform a garbage collection operation in a first time period; and
perform a write operation in response to a write operation instruction from a host in a second time period, wherein the first time period and the second time period occur alternately, and a resource usage indicator for the second time period is positively correlated with a non-valid page ratio of the memory device, wherein a non-valid page is in a memory block into which the write operation is writing in the second time period.

2. The memory system of claim 1, wherein the resource usage indicator for the second time period is indicative of at least one of:
a duration of the second time period; or
an amount of data written in the second time period.

3. The memory system of claim 2, wherein the resource usage indicator for the second time period is positively correlated with a resource collection indicator associated with performing the garbage collection operation in the first time period, positively correlated with the non-valid page ratio of the memory device, and negatively correlated with 1 minus the non-valid page ratio of the memory device.

4. The memory system of claim 3, wherein the resource collection indicator associated with performing the garbage collection operation in the first time period is indicative of at least one of:
a duration for performing the garbage collection operation in the first time period; or
a count of valid pages collected by performing the garbage collection operation in the first time period.

5. The memory system of claim 1, wherein the non-valid page ratio of the memory device is positively correlated with a free memory block count, positively correlated with a count of non-valid pages in the memory block into which the write operation is writing in the second time period, and negatively correlated with a total page count of the memory block.

6. The memory system of claim 1, wherein the memory controller is configured to:
determine that the memory system satisfies a force garbage collection condition.

7. The memory system of claim 6, wherein the force garbage collection condition comprises: a free memory block count of the memory system is less than a first threshold and greater than a second threshold.

8. The memory system of claim 7, wherein at least one of:
the first threshold is 9, 10, 11 or 12, and the second threshold is 4, 5 or 6; or
the second threshold corresponds to speed regulation gearing, and the first threshold is greater than the second threshold.

9. The memory system of claim 7, wherein at least one of:
a resource collection indicator associated with performing the garbage collection operation in the first time period is a fixed value; or
the memory controller is configured to:
perform an operation in a third time period between the first time period and the second time period, wherein the operation in the third time period includes a non-write operation.

10. The memory system of claim 9, wherein the resource collection indicator associated with performing the garbage collection operation in the first time period is indicative of a duration for performing the garbage collection operation in the first time period, and the duration for performing the garbage collection operation in the first time period includes 20-50 milliseconds.

11. The memory system of claim 9, wherein the resource usage indicator for the second time period is positively correlated with the resource collection indicator associated with performing the garbage collection operation in the first time period, positively correlated with the non-valid page ratio of the memory device, negatively correlated with 1 minus the non-valid page ratio of the memory device, and negatively correlated with a first balance influence factor, wherein the first balance influence factor represents an influence factor when the garbage collection operation in the first time period and the write operation in the second time period are balanced.

12. The memory system of claim 11, wherein the first balance influence factor is positively correlated with the resource collection indicator associated with performing the garbage collection operation in the first time period, negatively correlated with a count of free pages released by garbage collection, positively correlated with a logical saturation of valid page count of a first source memory block, negatively correlated with a total page count of the memory block, and negatively correlated with 1 minus a ratio of the logical saturation of valid page count of the first source memory block to the total page count of the memory block.

13. A memory controller comprising:
memory configured to store instructions; and
at least one processor circuit coupled to the memory and configured to execute the instructions to:
perform a garbage collection operation in a first time period; and
perform a write operation in response to a write operation instruction from a host in a second time period,
wherein the first time period and the second time period occur alternately, and a resource usage indicator for the second time period is positively correlated with a non-valid page ratio of a memory device, wherein a non-valid page is in a memory block into which the write operation is writing in the second time period.

14. The memory controller of claim 13, wherein the resource usage indicator for the second time period is indicative of at least one of:
a duration of the second time period; or
an amount of data written in the second time period.

15. The memory controller of claim 14, wherein the resource usage indicator for the second time period is positively correlated with a resource collection indicator associated with performing the garbage collection operation in the first time period, positively correlated with the non-valid page ratio of the memory device, and negatively correlated with 1 minus the non-valid page ratio of the memory device.

16. The memory controller of claim 15, wherein the resource collection indicator associated with performing the garbage collection operation in the first time period is indicative of at least one of:
a duration for performing the garbage collection operation in the first time period; or
a count of valid pages collected by performing the garbage collection operation in the first time period.

17. A method for operating a memory system, applied to a memory controller, the method comprising:
performing a garbage collection operation in a first time period; and
performing a write operation in response to a write operation instruction from a host in a second time period, wherein the first time period and the second time period occur alternately, and a resource usage indicator for the second time period is positively correlated with a non-valid page ratio of a memory device, wherein a non-valid page is in a memory block into which the write operation is writing in the second time period.

18. The method of claim 17, wherein the resource usage indicator for the second time period is indicative of at least one of:
a duration of the second time period; or
an amount of data written in the second time period.

19. The method of claim 18, wherein the resource usage indicator for the second time period is positively correlated with a resource collection indicator associated with performing the garbage collection operation in the first time period, positively correlated with the non-valid page ratio of the memory device, and negatively correlated with 1 minus the non-valid page ratio of the memory device.

20. The method of claim 19, wherein the resource collection indicator associated with performing the garbage collection operation in the first time period is indicative of at least one of:
a duration for performing the garbage collection operation in the first time period; or
a count of valid pages collected by performing the garbage collection operation in the first time period.
